(19) United States
(12) Patent Application Publication
(10) Pub. No.: US 2012/0159808 A1
(43) Pub. Date: Jun. 28, 2012

(54) LAUNDRY DRYER AND WASHER DRYER

(75) Inventors: Shigeharu Nakamoto, Hyogo (JP); Yuji Ozeki, Shiga (JP); Kouji Nakai, Kyoto (JP); Kenji Terai, Shiga (JP); Mitsuyuki Furubayashi, Shiga (JP)

(73) Assignee: Panasonic Corporation, Kadoma-shi, Osaka (JP)

(21) Appl. No.: 13/392,767

(22) PCT Filed: Oct. 8, 2010
(86) PCT No.: PCT/JP2010/006033

§ 371 Date: Mar. 14, 2012

(30) Foreign Application Priority Data
Oct. 16, 2009 (JP) 2009-238909

(51) Int. Cl. F26B 21/12; F26B 21/06; F26B 25/06

(52) U.S. Cl. 34/565; 34/232; 34/79

(57) ABSTRACT

Provided is a laundry dryer including: a first duct (9) having a first outlet (8) which opens at a rear side of a drum (1) for storing laundry, and a second duct (11) with a second outlet (10) which opens at a front side of the drum (1). The second outlet (10) has a narrower cross-sectional area, through which air passes, than the first outlet (8). The first or second duct (9, 10) is selectively switched during the drying process. A larger volume of dry air is blown from the first outlet (8) under selection of the first duct (9) than the second duct (11). The dry air is blown from the second outlet (10) at higher pressure and higher velocity under selection of the second duct (11) than the first duct (9).

### BACKGROUND OF THE INVENTION

1. Field of the Invention

The present invention relates to a laundry dryer which dries laundry and a washer dryer which has washing and drying functions for the laundry.

2. Description of the Related Art

A conventional drum-type laundry dryer or washer dryer blows dry air into a drum through a duct, so that the dry air comes into contact with the laundry, which is placed in the drum, and gets rid of moisture from the laundry to be dried. The dry air, which contains the moisture and becomes humid, is exhausted to the duct outside the drum. Since the laundry is typically dried within a limited and confined drum space, there are problems about strongly wrinkled laundry after the drying process. Various resolutions have been devised against the problems (c.f., Patent Document 1).

FIG. 8 shows a conventional drum-type washer dryer described in Patent Document 1. As shown in FIG. 8, the conventional drum-type washer dryer blows dry air from a first duct 121 and a second duct 122 into a rotary drum 123 to increase an air volume during the drying process and facilitate to evaporate moisture from the laundry 124, which results in shortened drying time. The air is blown at high velocity toward the laundry 124 placed inside the rotary drum 123 from a second outlet 125 of the second duct 122, which is situated at a lower portion of the rotary drum. The dry air is blown so as to move up and agitate the laundry 124. Therefore, it becomes less likely that the laundry 124 wrinkles, which, in turn, leads to improved end results of the drying process.

According to the conventional configuration, the air is blown to the laundry 124 at high pressure and high velocity. In general, if the air volume is the same level, a higher pressure and a higher velocity at which the air is blown, however, means an increase in load. Therefore, the motor used for a fan to blow the air consumes a lot of power. The conventional configuration uses two motors for the fans to increase the air volume blown into the rotary drum 123, which results in increased power consumption as well. Accordingly, the conventional drum-type washer dryer faces difficulties in stretching wrinkles in a short drying time with low power consumption.

Patent Document 1: JP 2009-72502 A

### SUMMARY OF THE INVENTION

An object of this invention is to provide a laundry dryer and a washer dryer, which consume low power to dry laundry with causing few wrinkles.

The laundry dryer according to one aspect of the present invention comprises a storage portion which stores laundry to be dried; a first duct having a first outlet which opens at a back side of the storage portion; a second duct having a second outlet which opens at a rear side of the storage portion, the second outlet having a narrower cross-sectional area, through which air passes, than the first outlet; a duct switcher which selectively switches between the first and second ducts; a blower which blows dry air so that a larger volume of the dry air is blown from the first outlet into the storage portion under selection of the first duct than the second duct and the dry air is blown at higher pressure and higher velocity from the second outlet into the storage portion under selection of the second duct than the first duct; and a controller which controls the duct switcher so that the first or second duct is selectively switched during a drying process.

The laundry dryer and washer dryer according to the present invention may consume less power to dry laundry with causing few wrinkles due to less power consumption at the blower.

The other objects, features and unique aspects of the present invention should be sufficiently understandable from the ensuing descriptions. The advantages of the present invention should be obvious from the ensuing explanation which is given with reference to the appended drawings.

### BRIEF DESCRIPTION OF THE DRAWINGS

FIG. 1 is a lateral cross-sectional view schematically showing a configuration of the drum-type washer dryer according to one embodiment of the present invention.

FIG. 2 is a block diagram showing a schematic configuration of the drum-type washer dryer.

FIG. 3 is a time chart exemplifying first switching timings of the duct in the drum-type washer dryer.

FIG. 4 is a time chart exemplifying second switching timing of duct in the drum-type washer dryer.

FIG. 5 is a time chart exemplifying third switching timing of duct in the drum-type washer dryer.

FIG. 6 is a time chart exemplifying fourth switching timing of duct in the drum-type washer dryer.

FIG. 7 is another time chart exemplifying fourth switching timing of the duct in the drum-type washer dryer.

FIG. 8 is a lateral cross sectional view schematically showing a configuration of a conventional drum-type washer dryer.

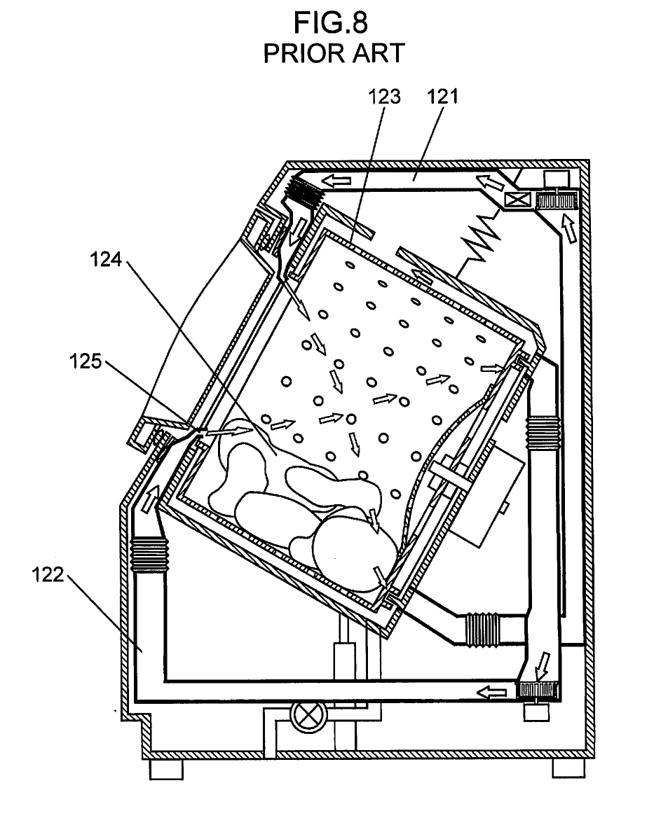

### DETAILED DESCRIPTION OF THE PREFERRED EMBODIMENTS

The exemplary drum-type washer dryer of the present invention is described with reference to the accompanying drawings. It should be noted that the following embodiments are examples for embodying the present invention, and are not intended for limiting any technical scopes of the present invention.

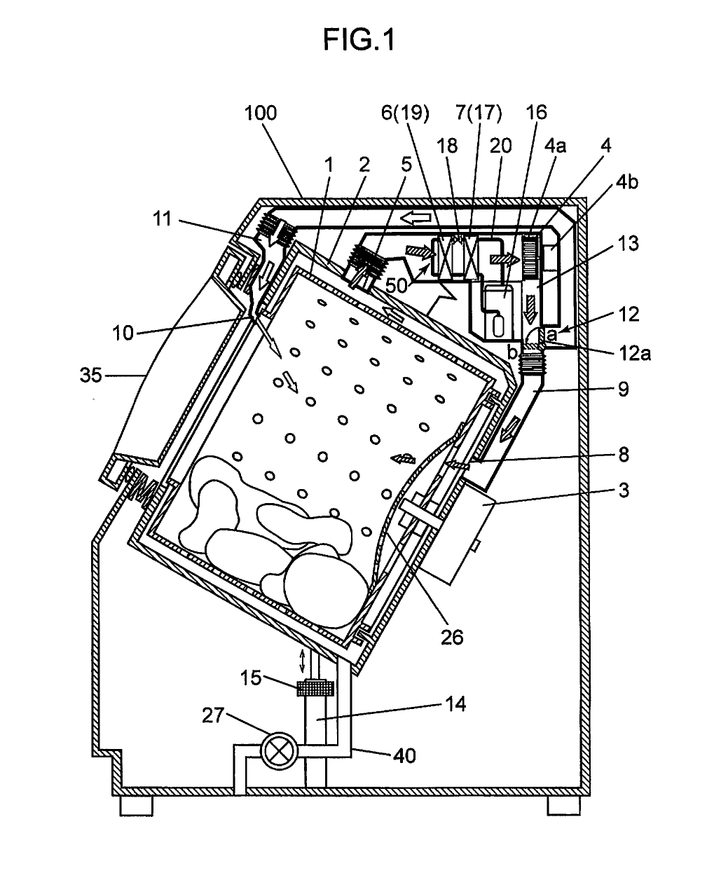

FIG. 1 is a lateral cross sectional view of the drum-type washer dryer according to one embodiment of the present invention.

In FIG. 1, a cylindrical drum 1 (storage portion), which opens forward and has a bottom surface to store laundry, is supported inside the housing 100. The cylindrical drum 1 is stored in a cylindrical water tub 2 which stores wash water. A drum drive motor 3 (drum driver) is mounted on the rear surface of the water tub 2. The drum drive motor 3 rotates the drum 1 around the rotating axis which is inclined upward to the front.

The housing 100 is provided with a door 35 which faces the open-end side of the drum 1, so that a user may open the door 35 to place and take out laundry (clothes) in and from the drum 1. A water supply pipe, on which a water supply valve (not shown) is mounted, and a drain pipe 40, on which a drain valve 27 is mounted, are connected to the water tub 2.

A blower 4 blows dry air to dry the laundry, so that the dry air getting rid of moisture from the laundry in the drum 1 becomes humid. The dry air then passes through an exhaust outlet 5 situated on the circumferential surface of the drum 1 and is exhausted outside the drum 1. The exhausted dry air is dehumidified by a dehumidifier 6. The dehumidified dry air by the dehumidifier 6 is then heated by a heater 7. The heated dry air is guided by one of a first duct 9 or a second duct 11, and is once again blown into the drum 1. The first duct 9 includes a first outlet 8 which opens at the rear of the drum 1 whereas the second duct 11 includes a second outlet 10 which opens at the front periphery of the drum 1. The first outlet 8 of the first duct 9 has a larger cross-sectional area, through which the air passes, than the second outlet 10. A large volume of the dry air may be blown from the first outlet 8 in comparison to the second duct 11 due to less pressure loss of the first outlet 8. The second outlet 10 of the second duct 11 has a narrower cross-sectional area, through which the air passes, than the first outlet 8. The dry air is blown at higher pressure and higher velocity into the drum 1 in comparison to the first outlet 8.

In the case of drum-type washer dryers, it is usual to narrow a gap between the front of the rotary drum 1 and the water tub 2 as much as possible, in order to prevent the laundry from entering into the gap. The second outlet 10 may be placed in this narrow space because the second outlet 10 has the relatively narrow cross-sectional area, through which the air is blown at high pressure and high velocity, although it is spatially difficult to mount an exhaust outlet which has a wide opening to cause little pressure loss. On the other hand, there is a space wide enough at the rear end of the drum 1 to place the first outlet 8, which has a relatively large opening, on the bottom surface. If the first outlet 8 is covered with a cover 26 on which numerous perforations are formed at a large aperture ratio to allow air passage, it becomes less likely that the laundry enters in the first outlet 8. Accordingly, the first outlet 8, which has relatively small pressure loss, may be mounted on the bottom surface of the drum 1 at the rear.

If the laundry is agitated by the rotation of the drum 1 around the rotation axis which is inclined upward to the front, it becomes likely that small laundry such as socks, handkerchiefs and briefs gathers at the rear end of the drum 1. Meanwhile, it becomes likely that long laundry such as long-sleeved underwear, long pants, long-sleeved dress shirts and long-sleeved pajamas gathers at the front of the drum 1. Accordingly, if a mixture of small and long laundries is dried and if a large volume of the dry air is blown from the first outlet 8, which is situated at the rear end of the drum 1, the dry air comes into contact with the small laundry at first because the small laundry gathers at the back of the drum 1. The dry air then passes through the small laundry to reach the long laundry at the front of the drum 1. Thus, both the small and long laundries may be efficiently dried. In particular, the small laundry may be dried with relatively few wrinkles. It is likely that the long laundry wrinkles because sleeves and alike are likely to be twisted by the agitation during the drying process. If wind (dry air) is blown from the second outlet 10 at the front of the drum 1 and comes in contact with the long laundry, the drying speed may go up because the long laundry tends to gather at the front of the drum 1. If the wind (dry air) is blown from the second outlet 10 at high pressure and high velocity and comes into contact with the long laundry, it becomes likely that the long laundry is stretched. In addition, the long laundry is moved a lot by the wind, so that the wrinkles are also effectively decreased.

A duct switcher 12 is situated at the bifurcation of the first and second ducts 9, 11 which are situated at the downstream side of the blower 4. The duct switcher 12 is used to switch the passage of the dry air to one of the first and second ducts 9, 11. The duct switcher 12 comprises a valve 12a, which is pivotally supported at the bifurcation of the first and second ducts 9, 11, and a driver (not shown) which drives and rotates the valve 12a. If the valve 12a rotates to “a-side” in FIG. 1 to close the second duct 11, the first duct 9 opens, so that the dry air blown by the blower 4 may pass through the first duct 9. On the other hand, if the valve 12a rotates to “b-side” in FIG. 1 to close the first duct 9, the second duct 11 opens so that the dry air blown by the blower 4 may pass through the second duct 11.

The blower 4 and the duct switcher 12 are situated in a circulation duct 13. The dry air goes through the drum 1, the exhaust outlet 5, the dehumidifier 6 and the heater 7 sequentially and is blown out again from the first or second outlet 8, 10. Thus, the dry air is circulated in the drum-type washer dryer.

The blower 4 is situated between the heater 7 and the duct switcher 12. The dry air heated by the heater 7 is blown by the blower 4 toward the downstream side of the circulation duct 13. The blower 4 comprises a blast fan 4a and a blast fan motor 4b. The blower 4 rotates the blast fan 4a so that volumetric air flow through the first duct 9 becomes a predetermined air volume which is greater than the air volume through the second duct 11 if the duct switcher 12 switches to the first duct 9. If the duct switcher 12 switches to the second duct 11, the blast fan 4a is rotated so that the air passing through the second outlet 10 of the second duct 11 becomes a predetermined air velocity which is higher than the velocity of the air passing through the first outlet 8. For example, the velocity of the air passes through the first outlet 8 may be set to about 10 m/s while the velocity of the air passing through the second outlet 10 may be set to no less than 50 m/s. It should be noted that the velocities of the air passing through the first and second outlets 8, 10 are not limited to the aforementioned values. The air velocity may be set to any value as long as the air velocity through the second outlet is higher than the air velocity through the first outlet 8.

The drum-type washer dryer according to this embodiment operates the duct switcher 12 to switch between the first and second ducts 9, 11 during the drying process, so that a larger volume of the air passes through the first duct 9 than the second duct 11, and the air passes at higher velocity through the second outlet 10 of the second duct 11 than the first outlet 8.

The exhaust outlet 5 is relatively farther from the first outlet 8 than the second outlet 10 (i.e., the exhaust outlet 5 is relatively closer to the second outlet 10 and farther from the first outlet 8). Thus, the exhaust outlet 5 is closer to the front than the rear of the drum 1. The exhaust outlet 5 may be closer to the second outlet 10 at the front of the drum 1 so that the exhaust outlet 5 becomes the most distant from the first outlet 8.

The exhaust outlet 5 is situated in an upper portion of the drum 1, so that the dry air may be effectively exhausted upwardly after the contact with the laundry. It should be noted that the exhaust outlet 5 may be situated at another place than at the upper portion of the drum 1 in a drum-type laundry dryer, which excludes washing functions. The exhaust outlet 5 is preferably situated above the wash water level in the drum-type washer dryer because the exhaust outlet 5 may be affected by the wash water.

The second outlet 10 opens at a front upper portion of the drum 1. Accordingly, the dry air is effectively blown at high pressure and high velocity toward the laundry which is moved upward by the rotation of the drum 1. Thus, the wrinkles are effectively removed.

A damper 14 below the water tub 2 supports the water tub 2. The damper 14 damps resultant vibration of the water tub 2 from the rotation of the drum 1 under an unbalanced condition of weight because of uneven laundry distribution in the drum 1 during the spin-drying process and alike. The damper 14 is provided with a laundry amount detector 15 which detects vertical displacement of a damper shaft and alike, which results from a change in laundry weight in the supported water tub 2, to measure a laundry amount.

The drum-type washer dryer of this embodiment carries out a dehumidification and heating processes by means of the heat-pump technology. Therefore, the washer dryer has a heat pump device. The heat pump device has a compressor 16, which compresses refrigerant, a radiator 17, which emits heat of the refrigerant that becomes a high temperature and high pressure as a result of the compression, a neck portion 18, which decompresses the pressure of the pressurized refrigerant, a heat sink 19, which absorbs heat from the periphery by means of the refrigerant under resultant low pressure from the decompression, and a pipe line 20, which connects the aforementioned four elements to circulate the refrigerant. The heat sink 19 in the heat pump device is used as the aforementioned dehumidifier 6. The radiator 17 is used as the aforementioned heater 7.

It should be noted that the drum-type washer dryer is not limited to a heat pump-type system for drying laundry. For example, the dehumidifier 6 may be a water-cooling system which directly sprays water to the dry air. The heater 7 may be an electric heater.

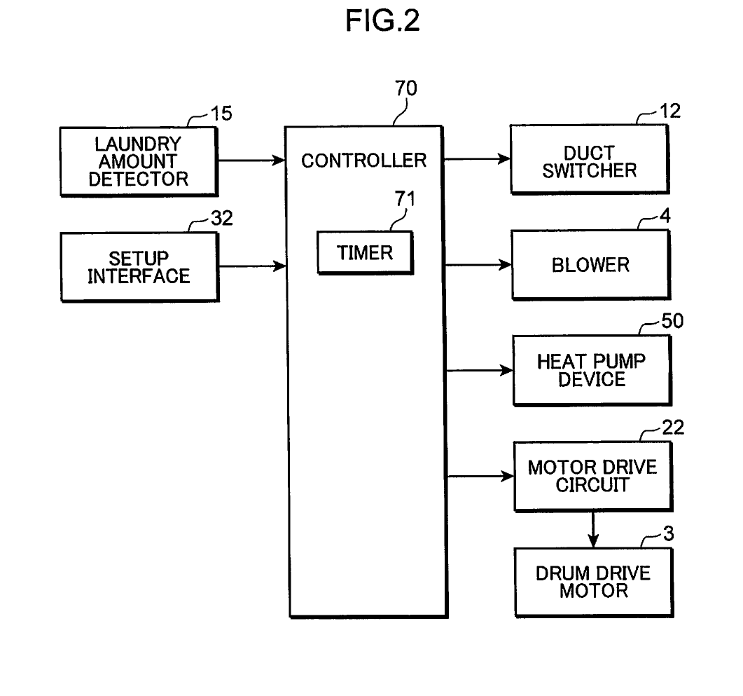

As shown in FIG. 2, the drum-type washer dryer includes a controller 70. The controller 70 controls a series of operations such as washing, rinsing, spin-drying and drying in response to setting information, which is input by the user via a setup interface 32, and monitored operational conditions of each component. For example, the controller 70 controls the rotation of the drum drive motor 3 via the motor drive circuit 22 and operations of the blower 4 and the heat pump device 50 in the drying process. The controller 70 also controls the duct switcher 12 to switch between the first and second ducts 9, 11. For example, the controller 70 may comprise a CPU (Central Processing Unit: not shown), a ROM (Read Only Memory), which stores programs, a RAM (Random Access Memory), which stores programs and data during execution of various processes, an I/O interface, and a bus, which connects these components to each other. The controller 70 includes a timer 71 which measures a first predetermined time and a second predetermined time, which are described later. An internal timer, which is built in the controller 70 as internal operation functions, may be used as the timer 71. It should be noted that a timer device, which is separate from the controller 70, may be used as the timer 71.

It should be noted that several first outlets 8 may be provided although only one first outlet 8 of the first duct 9 is provided in this embodiment. Likewise, several second outlets 10 may be provided although only one second outlet 10 of the second duct 11 is exemplarily shown.

Operations, works and effects of the aforementioned drum-type washer dryer are described in detail.

It is described at first how the laundry wrinkles during the drying process. If laundry is dried in a confined drum, numerous wrinkles remaining on the laundry may dissatisfy the user. This is because the laundry is not stretched well in the confined drum during the drying process. In particular, the laundry is likely to wrinkle if the laundry contains a lot of cotton. Thus, end results of the drying process become worse.

If moisture is contained in the cotton fibers, the fibers may freely move. Accordingly, even if the laundry is bent by a resultant mechanical force to the laundry from the agitation caused by the rotation of the drum, the bent portion is stretched so that no wrinkles remain if a subsequent force works to stretch the laundry is applied. If the moisture in the fibers decreases as progress of the drying process, a bonding force between the cotton fibers goes up and makes it difficult for the fibers to move. If a mechanical force bends the fibers, it becomes likely that the fibers keep bent. Subsequently, if the drying process further advances so that the moisture in the fibers further decreases, the fibers are likely to keep bent so that the fibers may not be easily stretched even under subsequent application of a force to stretch the laundry. Such a condition is referred to as “fixation of wrinkles”. The resultant fixation of wrinkles from a decrease in moisture contradicts the requirement to evaporation of the moisture to dry the laundry. The greater the fixation of wrinkles, the worse the end results of the drying process.

The fibers are inevitably bent in a confined drum. Reduction in wrinkles and avoidance from sharply bending the fibers to cause strong wrinkle fixation are the key to moderating the wrinkles Accordingly, it is preferable that the drying process advances with causing frequent changes in bending position to stretch and bend the fibers so that fibers are bent at one position and stretched at another position. If the drying advances under a stretched condition of the fibers which contain little moisture, a subsequent mechanical force is less likely to cause new wrinkles because the bonding between the fibers is too strong for the mechanical force to bend the fibers.

Accordingly, the drying process has ranges where the wrinkles become easily fixated and where the wrinkles is less likely to occur, which depend on a drying condition of the laundry. In terms of a dryness factor of laundry made from the cotton fibers, which are the most susceptible to wrinkles, if the dryness factor is ranged from substantially 85% (approximately 85%) to substantially 100% (approximately 100%), it is the most likely that the wrinkles are easily fixated on the laundry. In particular, if the dryness factor of the laundry made from the cotton fibers is ranged from substantially 90% (approximately 90%) to substantially 100% (approximately 100%), it is the most likely that the wrinkles are fixated on the laundry. The dryness factor (%) may be represented by the following formula.

Dryness factor (%)=(mass of standard laundry/mass of laundry containing moisture)×100

The term “mass of standard laundry” means the mass of laundry that is balanced under a condition at 20° C. of temperature and 65% of humidity.

Taking consideration of a dried condition of a single piece of a web, it is less likely that the web is evenly dried. Uneven dryness is partially observed on the web. For example, an area below the armpit of a long-sleeve shirt is not easily dried. Thus, it is usual that a target dryness factor at the completion of the drying process is not set to 100%. The drying process is designed so that the dryness factor exceeds 100% (e.g., dryness factor of 102% to 105%) at the end of the drying process to achieve an excessively dried condition. Accordingly, the drying process may be classified in response to the dryness factor into an early drying period until the dryness factor reaches substantially 90% just after the spin-drying process, during which it becomes less likely that wrinkles are fixated, a middle drying period from substantially 90% to substantially 100% of the dryness factor, during which it becomes likely that wrinkles are fixated, and a final drying period, during which the dryness factor exceeds 100% and the laundry hardly wrinkles.

In this embodiment, the wind is blown from the second outlet 10 of the second duct 11 at high pressure and high velocity to come into contact with the laundry during the middle drying period, so that the laundry is largely stretched to effectively reduce the wrinkles. A large air volume of wind is blown from the first outlet 8 of the first duct during at least one of the early and final drying periods. The switching operation between the first and second ducts 9, 11 in the drying process reduces wrinkles and saves power.

The timings of the early, middle and final drying periods in the drying process may be estimated on the basis of a time period from the start of the drying process. Thus, in this embodiment, the controller 70 determines the timings of the early, middle and final drying periods in the drying process on the basis of the time period from the start of the drying process to control the duct switcher 12, which switches between the first and second ducts 9, 11 on time. More specifically, the controller 70 determines a period from the start of the drying process to when the first predetermined time passes as the early drying period. The controller 70 determines a period from the end of the first predetermined time to when the second predetermined time, which takes longer than the first predetermined time from the start of the drying process, passes as the middle drying period. The controller 70 determines a period after the end of the second predetermined time to when the drying process ends as the final drying period.

As described above, the switching operation on time between the first and second ducts 9, 11 during the drying process causes few wrinkles and allows usage of the single blower 4. Since there is a time period, during which the laundry is dried by a large volumetric flow requiring less power than wind at high velocity, in the drying process, power consumption becomes relatively low in total, in comparison to conventional arts which use two blast fan motors to consistently blow out an increased volume of the dry air at high pressure and high velocity. Accordingly, the drum-type washer dryer of this embodiment may consume little power to achieve better end results of the drying process with few wrinkles on the laundry.

The exhaust outlet 5 is closer to the second outlet 10 at the front of the drum 1 and farther from the first outlet 8. Since the exhaust outlet 5 is situated at the front side of the drum 1, a distance between the first outlet 8 and the exhaust outlet 5 becomes long, so that the air blown from the first outlet 8 at the rear of the drum 1 is widely spread inside the drum 1. Thus, the dry air efficiently comes into contact with the laundry in the drum 1, so that the laundry may be dried with low power consumption.

The dry air may reach the rear from the front of the drum 1 even though the exhaust outlet 5 is closer to the second outlet 10 because the dry air is blown from the second outlet 10 at high pressure and high velocity. The contact between the dry air and the laundry may not be weakened so much under such a configuration. Therefore, the dry air at high pressure and high velocity still effectively stretches the wrinkles.

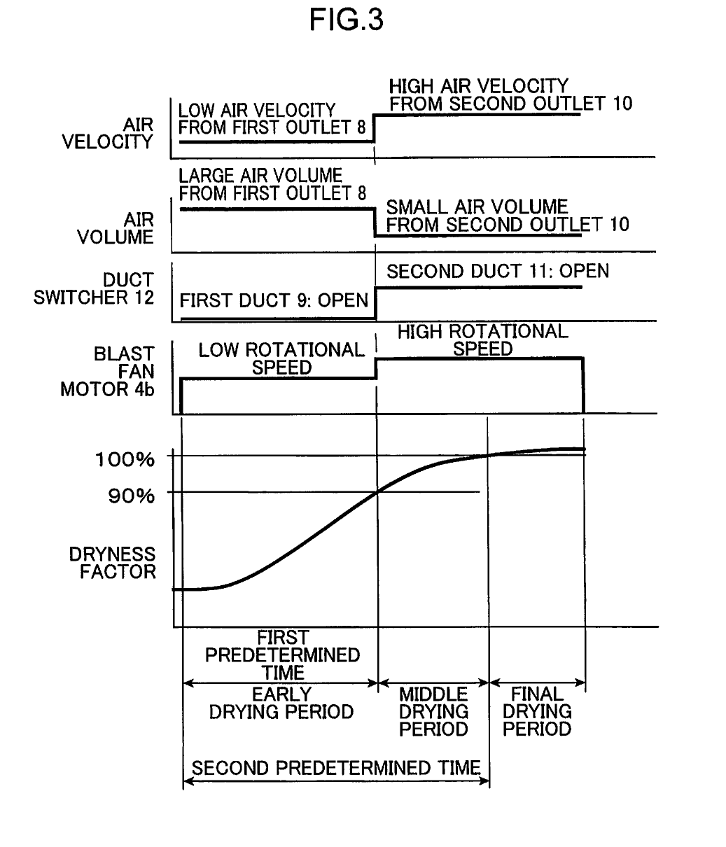

FIG. 3 is a time chart exemplifies the switching operation of the duct. The operation of the drum-type washer dryer, to which the first switching timing of the duct shown in FIG. 3 is applied, is described.

The first duct, which has a large cross section allowing air passage with small pressure loss, is used in the early drying period from the start of the drying process to when the first predetermined time passes in the drying process. Meanwhile, a large volume of the dry air is blown from the first outlet 8 at the rear of the drum 1 and comes into contact with the laundry. In short, the controller 70 controls the duct switcher 12 to open the first duct 9 and starts the drying operation. The controller 70 also uses the timer 71 to start timekeeping in synchronization with the start of the drying operation. The controller 70 keeps the first duct 9 opened until the first predetermined time passes. In this case, since the pressure loss of the first duct 9 is small, a large volumetric flow is obtained by a relatively low rotational speed set to the blast fan motor 4b. Therefore, the blower 4 may be driven with relatively low power consumption. Thus, the drying time period allocated as the early drying period may become short, which results in decreased power consumption during the early drying period.

In the middle drying period after the first predetermined time passes from the start of the drying operation and in the final drying period after the second predetermined time passes from the start of the drying operation, the duct switcher 12 switches to the second duct 11 and increases the rotational speed of the blast fan motor 4b. The moisture contained in the laundry after the spin-drying process considerably depends on types of fibers, texture of laundry and alike. In the case of laundry containing a lot of chemical fibers, the moisture content after the spin-drying process; that is, the initial dryness factor is considerably high at nearly 90%. In the case of such laundry, it is likely that the wrinkles occur and become fixated in the early and middle drying periods. The dry air is, however, consistently blown from the second outlet of the second duct at high pressure and high velocity to stretch the laundry and reduce the wrinkles. Consequently, in the middle and final drying periods, the blast fan motor 4b is rotated at high speed to blow the dry air at high pressure and high velocity from the second outlet 10, which has a narrower cross-sectional area for the air passage than the first outlet 8.

In short, the controller 70 controls the duct switcher 12 to open the second duct 11 if the first predetermined time passes from the start of the drying operation, and also controls the blower 4 to increase the rotational speed of the blast fan motor 4b. The controller 70 then keeps the second duct 11 opened until the drying process ends. In this case, the wind at high pressure and high velocity consistently stretches the laundry to decrease the wrinkles.

Therefore, better end results of the drying process with few wrinkles on the laundry is obtained with smaller power consumption in total, in comparison to conventional arts which consistently use two blast fan motors to blow the dry air at high pressure and high velocity and increase the air volume.

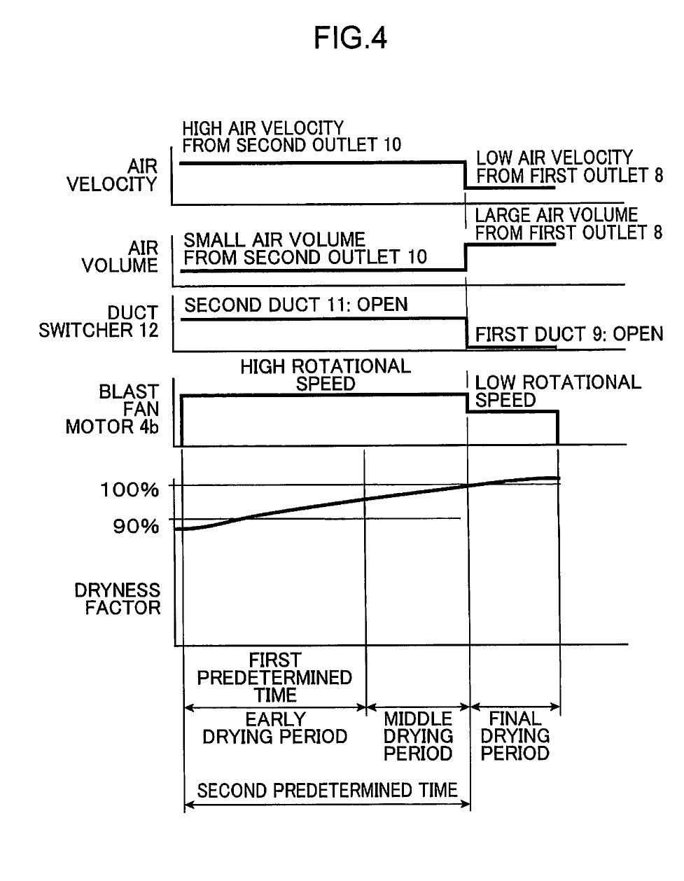

FIG. 4 is a time chart exemplifying another switching timing of the duct. The operation of the drum-type washer dryer, to which the second switching timing of the duct shown in FIG. 4 is applied, is described.

The second duct 11 is used during the early and middle drying periods, which are defined by the first and second predetermined time from the start of the drying operation, respectively. Meanwhile, the blast fan motor 4b is rotated at high speed in the drying process to blow the dry air at high pressure and high velocity from the second outlet 10, which has a narrow cross-sectional area allowing the air passage and is closer to the exhaust outlet. The dry air comes into contact with the laundry. In short, the controller 70 controls the duct switcher 12 to open the second duct 11, and starts the drying operation. The controller 70 also uses the timer 71 to start timekeeping in synchronism with the start of the drying operation. The controller 70 keeps the second duct 11 opened until the second predetermined time passes. In this case, the wind at high pressure and high velocity consistently stretches the laundry to reduce the wrinkles.

Subsequently, the duct switcher 12 switches to the first duct 9 in the final drying period after the second predetermined time passes. In the final drying period, the moisture contained in the laundry is small, so that it takes a long time for the dry air to hit and evaporate such a small amount of the moisture. Under such a condition, it is necessary to blow a large volume of the dry air into the drum 1 and make the dry air frequently hit the moisture. Therefore, it is preferable to obtain a large volumetric flow with low power consumption. Thus, the first duct 9, which has a large cross-sectional area allowing the air passage with small pressure loss, is used to blow out a large volume of the dry air from the first outlet 8 at the rear of the drum 1, so that the dry air comes into contact with the laundry. In short, the controller 70 controls the duct switcher 12 to open the first duct 9 if the second predetermined time passes from the start of the drying operation, and also controls the blower 4 to decrease the rotational speed of the blast fan motor 4b. Subsequently, the controller 70 keeps the first duct 9 opened until the drying process ends. In this case, since the pressure loss of the first duct 9 is small, a large volumetric air flow is obtained by relatively low rotational speed of the blast fan motor 4b. Therefore, the blower 4 is driven with relatively low power consumption. Thus, the drying time allocated as the final drying period may be shortened to decrease the power consumption during the final drying period.

Therefore, better end results of the drying process with few wrinkles on the laundry is obtained with smaller power consumption in total, in comparison to conventional arts which consistently use two blast fan motors to blow the dry air at high pressure and high velocity and increase the air volume.

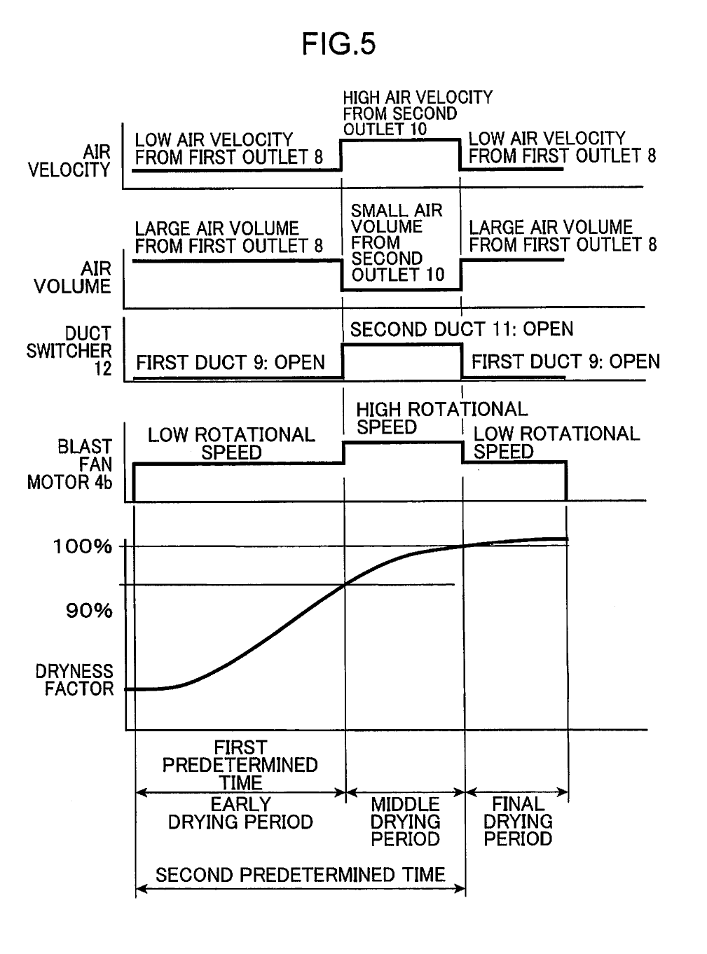

FIG. 5 is a time chart exemplifying another switching timing of the duct. The operation of the drum-type washer dryer, to which the third switching timing of the duct shown in FIG. 5 is applied, is described.

The first duct 9, which has a large cross-sectional area allowing the air passage, is used during the early drying period from the start of the drying operation to when the first predetermined time passes in the drying process to blow a large volume of the dry air from the first outlet 8 at the rear of the drum 1, so that the dry air comes into contact with the laundry. In short, the controller 70 controls the duct switcher 12 to open the first duct 9, and starts the drying operation. The controller 70 also uses the timer 71 to start timekeeping in synchronization with the start of the drying operation. The controller 70 keeps the first duct 9 opened until the first predetermined time passes. In this case, since the pressure loss of the first duct 9 is small, a large volumetric air flow is obtained by relatively low speed of the blast fan motor 4b. Therefore, the blower 4 is driven with relatively low power consumption. Thus, the drying time allocated as the first drying period may be shortened to decrease the power consumption during the early drying period.

In the middle drying period after the first predetermined time passes from the start of the drying operation, the duct switcher 12 switches to the second duct 11 while the rotational speed of the blast fan motor 4b is increased. Consequently, in the middle drying period, the blast fan motor 4b rotates at high speed to blow the dry air at high pressure and high velocity from the second outlet 10, which has a narrower cross-sectional area allowing the air passage than the first outlet 8. In short, the controller 70 controls the duct switcher 12 to open the second duct 9 if the first predetermined time passes from the start of the drying operation, and also controls the blower 4 to increase the rotational speed of the blast fan motor 4b. Subsequently, the controller 70 keeps the first duct 11 opened until the second predetermined time passes. In this case, the wind at high pressure and high velocity consistently stretches the laundry to decrease the wrinkles.

The duct switcher 12 then switches to the first duct 9 for the final drying period after the second predetermined time passes. In the final drying period, the moisture contained in the laundry is small. Therefore, it takes a long time for the dry air to hit and evaporate such a small amount of the moisture. Under such a condition, it is necessary to blow a large volume of the dry air into the drum 1 and make the dry air frequently come into contact with the moisture. Therefore, it is preferable to obtain a large air volume with low power consumption. Thus, the first duct 9, which has a large cross-sectional area allowing the air passage with small pressure loss, is used to blow out a large volume of the dry air from the first outlet 8 at the rear of the drum 1, so that the dry air comes into contact with the laundry. In short, the controller 70 controls the duct switcher 12 to open the first duct 9 if the second predetermined time passes from the start of the drying operation, and also controls the blower 4 to decrease the rotational speed of the blast fan motor 4b. Subsequently, the controller 70 keeps the first duct 9 opened until the drying process ends. In this case, since the pressure loss of the first duct 9 is small, a large volume of the wind is obtained by relatively low rotational speed of the blast fan motor 4b. Therefore, the blower 4 is driven with relatively low power consumption. Thus, the drying time allocated as the final drying period may be shortened to decrease the power consumption during the final drying period.

Therefore, better end results of the drying process with few wrinkles on the laundry is obtained with smaller power consumption in total, in comparison to conventional arts which consistently use two blast fan motors to blow the dry air at high pressure and high velocity and increase the air volume.

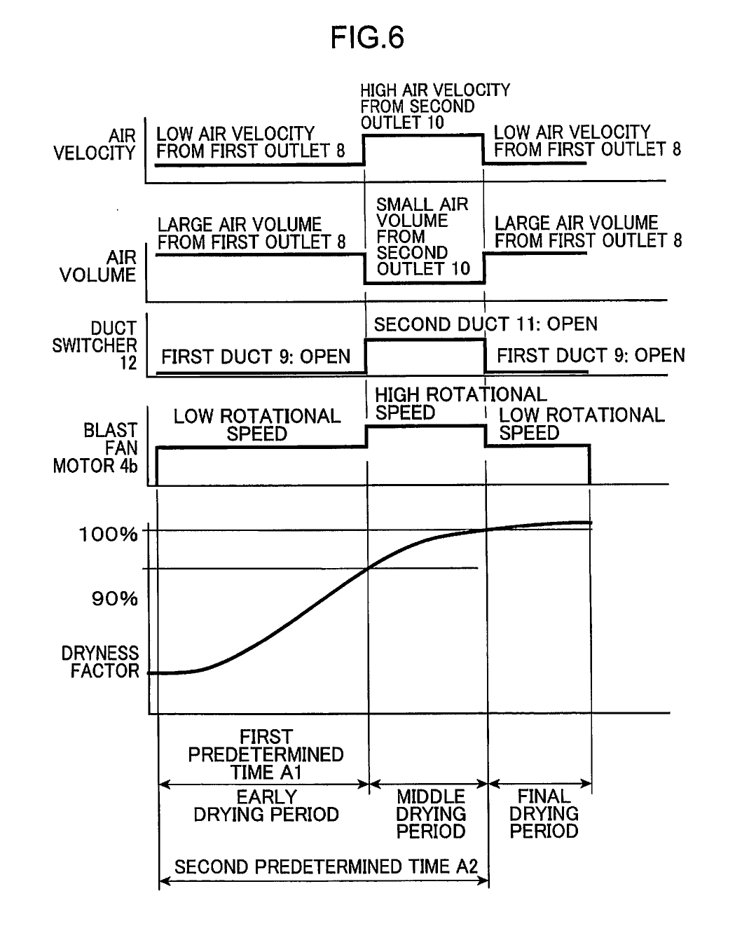

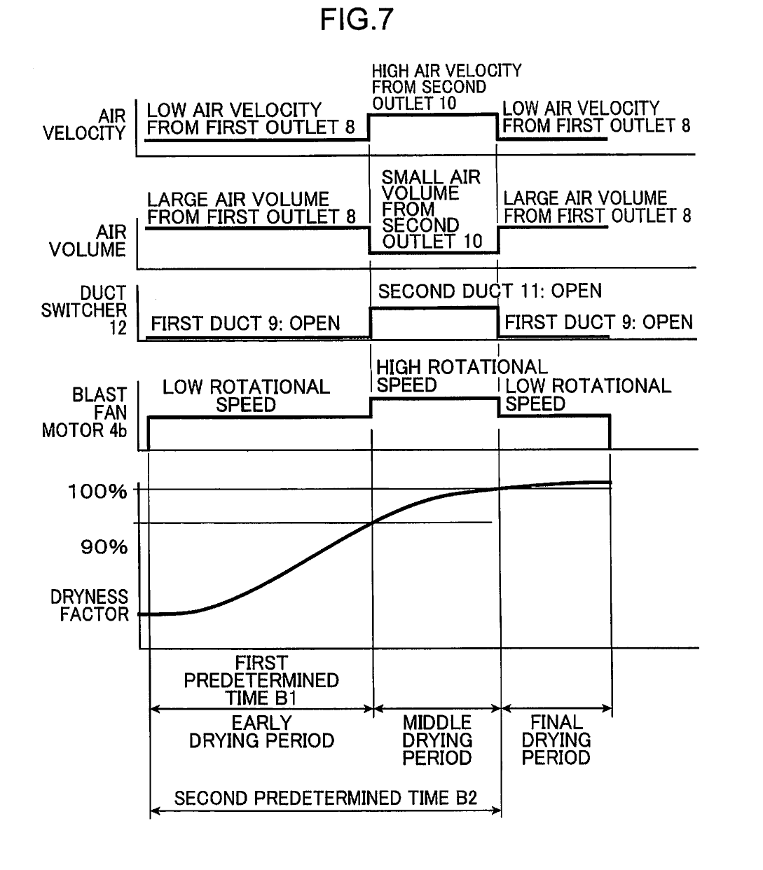

FIGS. 6 and 7 are time charts exemplifying another switching timing of the duct. The operation of the drum-type washer dryer, to which the fourth switching timing of the duct shown in FIGS. 6 and 7 is applied, is described.

As described above, the controller 70 determines the timing of the early, middle and final drying periods, respectively, on the basis of the time periods (the first and second predetermined times) from the start of the drying process. The entire time length of the drying process as well as the time length of each drying period, however, depends on a laundry amount to be dried. Thus, in this embodiment, the laundry amount detector 15 is used to detect the laundry amount to be dried, so that the first and second predetermined times, which are used as criteria of each drying period, are changed in response to the detection results.

The laundry amount detector 15 detects an amount (mass) of the laundry placed in the drum 1 before the start of the washing process. Specifically, the laundry amount detector 15 detects the amount of the laundry placed in the drum 1 on the basis of a difference between a shaft position of the damper 14 when the water tub 2 is empty (i.e., there is no water in the water tub 2 and no laundry is placed in the drum 1) and a shaft position of the damper 14 before the start of the washing process to supply water into the water tub 2 (i.e. there is no water in the water tub 2 while the laundry is placed in the drum 1).

The controller 70 then sets the first and second predetermined times in response to the detection results of the laundry amount detector 15. FIG. 6 shows operations under a condition where the amount of the laundry to be dried is less than FIG. 7. If the laundry amount is small, the controller 70 sets the first predetermined time to Al and the second predetermined time to A2 as shown in FIG. 6. On the other hand, if the laundry amount is great, the controller 70 sets the first predetermined time to B1 and the second predetermined time to B2 as shown in FIG. 7. The entire time length of the drying process is longer in the case of FIG. 7 than FIG. 6. The timing at which the dryness factor reaches 90% or 100% is also delayed in the case of FIG. 7 in comparison with FIG. 6. Thus, the controller 70 sets the first and second predetermined times to achieve “A1<B1” and “A2<B2”. In short, the controller 70 lengthens the first and second predetermined times as the laundry amount to be dried increases.

As a result of optimizing each period of the early, middle and final drying periods in response to the laundry amount to be dried as described above, the first and second ducts 9, 11 may be effectively switched in the drying process to obtain better end results of the drying process with few wrinkles on laundry and with smaller total power consumption, in comparison to conventional arts which consistently use two blast fan motors to blow out the dry air at high pressure and high velocity and increase the air volume.

It should be noted that the adjustment to the first and second predetermined times in response to the detection results of the laundry amount may be applied to any one of the first to third switching timings of the duct shown in FIGS. 3 to 5.

The vertical displacement of the shaft of the damper 14 is exemplarily detected by the laundry amount detector 15 but the present embodiment is not limited thereto. For example, the laundry amount detector may detect changes in parameters such as load, rotational speed, drive current, torque or alike of the drum drive motor 3 to identify the laundry amount in the drum 1 from the variance of the load of the drum drive motor 3.

The exemplary controller 70 automatically adjusts the first and second predetermined times in response to the detection results of the laundry amount detector 15 in this embodiment. Even without the laundry amount detector 15, the user may input the laundry amount to the setup interface 32, so that the controller 70 changes the first and second predetermined times in response to the user input.

The drum-type washer dryer, which has the washing function as well as the laundry drying function, is explained but the present invention is not limited thereto. The present invention may be applied to a laundry dryer without the washing function. It may be exemplified as the laundry dryer if the washing function is excluded from the drum-type washer dryer shown in FIG. 1. For example, the laundry dryer without the washing function does not require any connection of the water supply pipe or drain pipe 40 to the water tub 2 of FIG. 1. Thus, the water tube 2 may work as an outer shell of the drum 1 while other configurations of the drum-type washer dryer of FIG. 1 are kept the same.

The present invention is applied to the drum-type washer dryer in the described embodiment but the present invention is not limited to the drum-type washer dryer. In short, since the laundry dryer and the washer dryer of the present invention aim to reduce the total power consumption of the blast fan motor, shorten the drying period, and make the laundry dried with few wrinkles and with low power consumption, the present invention may be applied to hang-type drying or pulsator-type vertical washer dryers other than drum-type washer dryers.

The laundry dryer according to one aspect of the present invention comprises a storage portion which stores laundry to be dried; a first duct having a first outlet which opens at a rear side of the storage portion; a second duct having a second outlet which opens at a front side of the storage portion, the second outlet having a narrower cross-sectional area, through which air passes, than the first outlet; a duct switcher which selectively switches between the first and second ducts; a blower which blows dry air so that a larger volume of the dry air is blown from the first outlet into the storage portion under selection of the first duct than the second duct and the dry air is blown at higher pressure and higher velocity from the second outlet into the storage portion under selection of the second duct than the first duct; and a controller which controls the duct switcher so that the first or second duct is selectively switched during a drying process.

According to the aforementioned configuration, the drying process execution is separated into a process to dry laundry with less power consumption and a process to consistently move the laundry so that fibers are stretched with little wrinkle fixation, in response to progress of laundry dryness and a condition of wrinkle fixation from the start to the end of the drying process.

In other words, two ducts; namely, the first and second ducts are used to direct the dry air to the storage portion which stores the laundry. These two ducts may be switched by the duct switcher. The first outlet of the first duct has a wider cross-sectional area through which air passes and less pressure loss than the second outlet of the second duct. A larger volume of the dry air is blown from the first outlet into the storage portion, under selection of the first outlet which opens at the rear side of the storage portion, than under selection of the second outlet. The larger volume of the dry air blown through the first duct, which has the wider cross-sectional area allowing the air passage with less pressure loss, hits the wet laundry during an early phase of the drying operation so as to evaporate moisture a lot and shorten the drying time. In this case, the blower may be driven with relatively low power consumption to obtain the large air volume due to the low pressure loss. Thus, the time of drying operation with the large air volume is shortened, which results in decreased power consumption.

On the other hand, the second outlet of the second duct has a narrower cross-section, through which the air passes, than the first outlet. The dry air is blown from the second outlet into the storage portion at higher pressure and higher velocity under selection of the second duct, which opens at the front side of the storage portion, than the selection of the first duct. In this case, the laundry (long-sleeve clothes and alike which tend to gather toward the front of the storage portion) is stretched by the air at high-pressure and high-velocity to reduce wrinkles. As a result of selectively switching between the aforementioned first and second ducts during the drying process (e.g., the first duct is selected while it is less likely that the laundry becomes wrinkled, and the second duct is selected while it is likely that the laundry becomes wrinkled), the laundry may be dried with one blower. During the drying process, the laundry is dried with the large volume air, which consumes less power than the air at high velocity. Therefore, the drying process causes few wrinkles and consumes little power.

In the above configuration, preferably, an exhaust outlet, through which the dry air is exhausted outside the storage portion, is closer to the second outlet and farther from the first outlet.

According to the aforementioned configuration, with regard to a relative positional relationship among the exhaust outlet, the first and second outlets, the exhaust outlet is closer to the first outlet whereas the exhaust outlet is farther from the second outlet. As a result of the aforementioned long distance between the exhaust outlet and the second outlet, the dry air efficiently hits the laundry in the storage portion while the air is blown from the first outlet, so that the laundry may be efficiently dried with low power consumption. On the other hand, even if the exhaust outlet is closer to the second outlet, the dry air may reach a distant position from the exhaust outlet due to the high pressure and high velocity of the dry air, which is blown out from the second outlet. Therefore, the wrinkles may be still effectively stretched since the dry air preferably hits the laundry. Therefore, there may be less power consumption and few wrinkles on the finished laundry after the drying process in comparison to conventional arts in which two blowers are consistently used to blow an increased volume of the dry air at high pressure and high velocity.

The aforementioned controller preferably selects the second duct so that the dry air is blown from the second outlet at the high pressure and high velocity at least during the middle drying period in which the dryness factor of the laundry in the storage portion is substantially in the range from 90% to 100%.

In the aforementioned configuration, it is likely that wrinkles occur and become fixated in the middle drying period, in which the dryness factor of the laundry becomes substantially in the range from 90% to 100%, during the drying process. The dry air is blown from the second outlet at high pressure and high velocity at least during the middle drying period so as to effectively reduce wrinkles.

The aforementioned controller preferably selects the first duct so that the larger volume of the dry air is blown from the first outlet during the early drying period which continues the first predetermined time from the start of the drying process, and selects the second duct so that the dry air is blown from the second outlet at high pressure and high velocity from a middle drying period after the first predetermined time.

In the aforementioned configuration, the first duct, which has a wide cross-sectional area that allows air passage with small pressure loss, is used during the early drying period which continues the first predetermined time from the start of the drying process, so that the large volume of the dry air hits the laundry. In this case, the blower may consume little power to cause the large air volume due to the little pressure loss of the first duct. Thus, the drying time with the large air volume is shortened, which results in decreased power consumption. The duct is switched to the second duct from the middle drying period after the first predetermined time. It is likely that the wrinkles occur and become fixated during the middle drying period. The laundry is consistently stretched by the dry air, which is blown from the second outlet at high pressure and high velocity dry air to decrease the wrinkles. Therefore, there are better end results of the drying process with decreased wrinkles and lower power consumption in total, in comparison to conventional arts in which two blowers are consistently used to blow an increased volume of the dry air at high pressure and high velocity.

The aforementioned controller preferably selects the first duct once again so that the large volume of the dry air is blown from the first outlet during a final drying period which continues a longer second predetermined time from the start of the drying process than the first predetermined time.

According to the aforementioned configuration, the duct is switched once again to the first duct during the final drying period after the second predetermined time from the start of the drying process. In the final drying period, the moisture contained in the laundry is small. Therefore, it takes a long time for the dry air to hit and evaporate the small amount of moisture. In such a condition, the large volume of the dry air has to be blown into the storage portion, so that the dry air frequently hits the moisture. It is preferable to obtain the large air volume with low power consumption. Thus, the first duct, which has a wide cross-sectional area allowing air passage with small pressure loss, is used to make the large volume of the dry air hit the laundry. In this case, the small pressure loss of the first duct results in low power consumption for driving the blower to cause the large air volumetric flow. Thus, it may take a shorter time to dry the laundry in the final drying period, which results in decreased power consumption during the final drying period. Accordingly, the power consumption is decreased in total.

The aforementioned controller preferably selects the second duct so that the dry air is blown from the second outlet at high pressure and high velocity during an early drying period and a middle drying period which continues the second predetermined time from the start of the drying process, and selects the first duct so that the large volume of the dry air is blown from the first outlet during the final drying period after the second predetermined time.

According to the aforementioned configuration, the second duct is used during the early and middle drying periods which continue the second predetermined time from the start of the drying process. The moisture contained in the laundry after the spin-drying considerably depends on types of fiber, texture and alike of the laundry. In the case of laundry which contains numerous chemical fibers, the contained moisture after the spin-drying; that is, the initial dryness factor is considerably high at nearly 90%. In the case of such laundry, it is likely that the wrinkles occur and become fixated during the early and middle drying periods. The laundry is, however, consistently stretched by the dry air, which is blown from the second outlet of the second duct at high pressure and high velocity to reduce the wrinkles. Subsequently, the first duct is used in the final drying period after the second predetermined time. As described above, in the final drying period, the contained moisture in the laundry is small, so that it takes a long time for the dry air to hit and evaporate such a small amount of moisture. Thus, the large volume of the dry air is blown out from the first outlet of the first duct into the storage portion in order to make the dry air frequently hit the moisture during the final drying period. In this case, the large air volumetric flow may be obtained by the blower, which is driven with low power consumption, since the pressure loss of the first duct is small. Thus, a shorter final drying period may be required for the drying process, which results in decreased power consumption during the final drying period. Accordingly, it requires less power to achieve preferable end results of the drying process with few wrinkles on the laundry in comparison to conventional arts in which two blowers are used to consistently blow an increased volume of the dry air at high pressure and high velocity.

In the aforementioned configuration, preferably, the laundry dryer further comprises a laundry amount detector which detects a laundry amount in the storage portion, wherein the controller sets the first or second predetermined time in response to the laundry amount detected by the laundry amount detector.

In the aforementioned configuration, if there is a large amount of laundry in the storage portion, the drying time becomes longer by the laundry amount. Thus, preferably, the first or second predetermined time is extended. On the other hand, the required drying time may become shortened if there is only a small amount of laundry. Preferably, the first or second predetermined time is shortened. Thus, the laundry amount detector which detects the laundry amount in the storage portion is provided to set the first or second predetermined time in response to the laundry amount. As a result of optimizing each of the early, middle and final drying period in response to the amount of the laundry to be dried as described above, the first and second ducts may be effectively switched in the drying process, which leads to preferable end results of the drying process with few wrinkles on the laundry and little power consumption.

In the aforementioned configuration, preferably, the storage portion is a cylindrical drum, and the laundry dryer further comprises: a drum driver which drives and rotates the drum; a dehumidifier which dehumidifies the dry air under humidity after exhaust from the drum; a heater which heats the dry air after dehumidification by the dehumidifier; and a circulation duct in which the blower and the duct switcher are situated, so that the dry air is circulated from the drum to the first or second outlet through the dehumidifier and the heater.

Like the aforementioned configuration, the so-called drum-type laundry dryer may utilize the drum as the storage portion. Since a drum-type laundry dryer dries the laundry in a limited and confined drum space, it is difficult to obtain preferable end results of the drying process with few wrinkles under power saving. However, according to the present invention, the drum-type laundry dryer may dry the laundry with few wrinkles under decreased power consumption.

In the aforementioned configuration, preferably, the second outlet opens at a front upper portion of the drum. Therefore, the dry air is effectively blown from the front upper portion of the drum toward the laundry at high pressure and high velocity to effectively decrease the wrinkles even if the laundry is moved up in response to the rotation of the drum.

The washer dryer according to the present invention includes any one of the aforementioned laundry dryers, and a water tub in which the storage portion is stored. The water tub stores wash water. Any one of the aforementioned laundry dryers may be utilized to fabricate a washer dryer configured to dry the laundry with few wrinkling under low power consumption.

The specific embodiments and examples described in the section of Description of the Invention are provided merely for clarifying technical contents of the present invention. Therefore, this invention should not be narrowly interpreted as being limited to such specific examples. This invention may be implemented by being variously modified within a scope of the spirit of the present invention and the ensuing claims.

### INDUSTRIAL APPLICABILITY

The laundry dryer and washer dryer of the present invention may be suitably applied to various types of laundry dryer and washer dryers such as drum-type, hang dry-type or pulsator-type dryers.

1. A laundry dryer, comprising:
a storage portion which stores laundry to be dried;
a first duct having a first outlet which opens at a rear side of the storage portion;
a second duct having a second outlet which opens at a front side of the storage portion, the second outlet having a narrower cross-sectional area, through which air passes, than the first outlet;
a duct switcher which selectively switches between the first and second ducts;
a blower which blows dry air so that a larger volume of the dry air is blown from the first outlet into the storage portion under selection of the first duct than the second duct and the dry air is blown at higher pressure and higher velocity from the second outlet into the storage portion under selection of the second duct than the first duct; and
a controller which controls the duct switcher so that the first or second duct is selectively switched during a drying process.

2. The laundry dryer according to claim 1, wherein
an exhaust outlet, through which the dry air is exhausted outside the storage portion, is closer to the second outlet and farther from the first outlet.

3. The laundry dryer according to claim 1, wherein
the controller selects the second duct so that the dry air is blown from the second outlet at higher pressure and higher velocity at least during a middle drying period in which a dryness factor of the laundry in the storage portion is substantially in a range from 90% to 100%.

4. The laundry dryer according to claim 1, wherein
the controller selects the first duct so that the larger volume of the dry air is blown from the first outlet during an early drying period, which continues a first predetermined time from a start of the drying process, and selects the second duct so that the dry air is blown from the second outlet at higher pressure and higher velocity after a middle drying period after the first predetermined time.

5. The laundry dryer according to claim 4, wherein
the controller selects the first duct once again so that the larger volume of the dry air is blown from the first outlet during a final drying period which continues a longer second predetermined time than the first predetermined time from the start of the drying process.

6. The laundry dryer according to claim 1, wherein
the controller selects the second duct so that the dry air is blown from the second outlet at higher pressure and higher velocity during an early drying period and a middle drying period which continue a second predetermined time from the start of the drying process, and selects the first duct so that the larger volume of the dry air is blown from the first outlet during a final drying period after the second predetermined time.

7. The laundry dryer according to claim 4, further comprising:
a laundry amount detector which detects a laundry amount in the storage portion, wherein
the controller sets the first or second predetermined time in response to the laundry amount detected by the laundry amount detector.

8. The laundry dryer according to claim 1, wherein
the storage portion is a cylindrical drum, and
the laundry dryer further comprises:
a drum driver which drives and rotates the drum;
a dehumidifier which dehumidifies the dry air under humidity after exhaust from the drum;
a heater which heats the dry air after dehumidification by the dehumidifier; and
a circulation duct in which the blower and the duct switcher are situated, so that the dry air is sequentially circulated from the drum to the first or second outlet through the dehumidifier and the heater.

9. The laundry dryer according to claim 8, wherein
the second outlet opens at a front upper portion of the drum.

10. A washer dryer, comprising:
the laundry dryer according to claim 1; and
a water tub in which the storage portion is stored, the water tub storing wash water.
